(19) United States
(12) Patent Application Publication
(10) Pub. No.: US 2026/0108107 A1
(43) Pub. Date: Apr. 23, 2026

(54) SHAKER CUP

(71) Applicant: Starbucks Corporation, Seattle, WA (US)

(72) Inventors: Jonathan Levey, Geneseo, NY (US); Megan C. Bolling, Bellevue, WA (US)

(21) Appl. No.: 19/356,700

(22) Filed: Oct. 13, 2025

Related U.S. Application Data
(60) Provisional application No. 63/709,376, filed on Oct. 18, 2024.

(51) Int. Cl. A47J 43/27; B65D 1/26

(52) U.S. Cl. CPC A47J 43/27; B65D 1/265; B65D 2203/04

(57) ABSTRACT

Generally described, one or more aspects of the present disclosure relate to methods, systems, and devices related to a shaker cup and serving cup assembly including a shaker cup, a first serving cup of a first size and a second serving cup of a second size. The shaker cup having a body defining a first interior, a rim defining an opening, a first ridge positioned below the rim, and a second ridge positioned below the first ridge, The first ridge diameter is larger than the second ridge diameter. The first ridge of the shaker cup is configured to receive the first serving cup, and the second ridge of the shaker cup is configured to receive the second serving cup. The shaker cup having a solid fill indicia indicating a volume of granular solid and a liquid fill indicia indicating a volume of liquid.

### INCORPORATION BY REFERENCE TO ANY PRIORITY APPLICATIONS

This application claims priority to U.S. Provisional Patent Application No. 63/709376, filed Oct. 18, 2024, the entirety of which is incorporated herein by reference.

### FIELD

The present disclosure relates to systems and methods for preparing a beverage, such as, in certain embodiments, systems and methods for preparing a shaken beverage using a shaker cup.

### DESCRIPTION OF THE CERTAIN RELATED ART

Certain beverages are prepared by shaking, which can be executed in a cup with a lid. The beverage can be poured into a cup, the vessel can be closed, such as with a lid. The closed vessel can be shaken to shake the beverage. Shaking the beverage can incorporate all ingredients to create a more homogenous beverage. In some processes, ice is added to the beverage and shaking the beverage can more quickly lower the temperature of the beverage. In some processes, shaking the beverage can create frothiness in the beverage.

### SUMMARY

The systems, methods and devices of this disclosure each have several innovative aspects, no single one of which is solely responsible for the desirable attributes disclosed herein.

A shaker cup can include a body defining a first interior, a rim defining an opening, a first ridge of a first ridge diameter positioned below the rim, the first ridge configured to receive a first serving cup of a first size, and a second ridge of a second ridge diameter positioned below the first ridge, the second ridge configured to receive a second serving cup of a second size. The first ridge diameter can be larger than the second ridge diameter.

In some configurations, the first ridge can include a first planar surface that is concentric to the rim, and the second ridge can include a second planar surface that is concentric to the first ridge. In some configurations, the shaker cup can include a first sidewall positioned between the rim and the first ridge and a second sidewall positioned between the first ridge and the second ridge. In some configurations, the first planar surface of the first ridge can be configured to extend at a first angle relative to the first sidewall, and the second planar surface of the second ridge can be configured to extend at a second angle relative to the second sidewall, and the first angle and the second angle can each be between 90 degrees to 145 degrees. In some configurations, the first sidewall can be configured to form a first radial seal with the first serving cup, and the second sidewall can be configured to form a second radial seal with the second serving cup. In some configurations, the first planar surface can be configured to form a first face seal with the first serving cup, and the second planar surface can be configured to form a second face seal with the second serving cup. In some configurations, the first ridge diameter of the first ridge can be configured to receive a first cup diameter of the first serving cup. In some configurations, the second ridge diameter of the second ridge can be configured to receive a second cup diameter of the second serving cup. In some configurations, the first ridge and the second ridge can be configured to form a stepped profile. In some configurations, the shaker cup can include a third ridge of a third ridge diameter positioned below the second ridge, and the third ridge diameter can be smaller than the second ridge diameter of the second ridge. In some configurations, the rim can include a lip that extends radially such that the lip defines an outer circumferential edge of the opening of the shaker cup.

In another aspect, a shaker cup and serving cup assembly can include a shaker cup, a first serving cup of a first size, and a second serving cup of a second size. The shaker cup can include a body defining a first interior, a rim defining an opening, a first ridge of a first ridge diameter positioned below the rim, and a second ridge of a second ridge diameter positioned below the first ridge. The first ridge diameter can be larger than the second ridge diameter. The first size and the second size can be different. The first ridge of the shaker cup can be configured to receive the first serving cup and the second ridge of the shaker cup can be configured to receive the second serving cup.

In some configurations, the first serving cup can be configured to be inverted such that an open end of the first serving cup can be positioned below a closed end of the first serving cup when the first serving cup is received by the shaker cup. In some configurations, the shaker cup can include a first material, and the first serving cup and the second serving cup can include a second material. The first material can be more rigid than the second material. In some configurations, the first ridge can include a first planar surface that is concentric to the rim, and the second ridge can include a second planar surface that is concentric to the first ridge. In some configurations, a planar surface of a rim of the first serving cup can be configured to be positioned against the first planar surface of the first ridge of the shaker cup when the shaker cup receives the first serving cup, and a planar surface of a rim of the second serving cup can be configured to be positioned against the second planar surface of the second ridge of the shaker cup when the shaker cup receives the second serving cup. In some configurations, the shaker cup can include a first sidewall positioned between the rim and the first ridge, and the shaker cup can include a second sidewall positioned between the first ridge and the second ridge. In some configurations, an outer circumferential surface of a rim of the first serving cup can be configured to form a first radial seal with the first sidewall when the shaker cup receives the first serving cup, and an outer circumferential surface of a rim of the second serving cup can be configured to form a second radial seal of the second sidewall when the shaker cup receives the second serving cup. In some configurations, a longitudinal axis of the shaker cup and a longitudinal axis of the first or second serving cup can be configured to be aligned. In some configurations, the rim can include a lip that extends radially such that the lip defines an outer circumferential edge of the opening of the shaker cup.

In another aspect, a shaker cup and lid assembly can include a shaker cup and a lid. The shaker cup can include a body defining a first interior, a rim defining an opening, a first ridge of a first ridge diameter positioned below the rim, and a second ridge of a second diameter positioned below the first ridge. The first ridge diameter can be larger than the second ridge diameter. The lid can include a handle and a base. The base can include a projection extending radially from an outer circumferential surface of the base and a distal end extending distally from the projection.

In some configurations, the distal end of the base can be configured to fit within the opening of the shaker cup to form a seal. In some configurations, an outer circumferential surface of the distal end of the base can form a radial seal with an inner surface of the opening of the shaker cup. In some configurations, the rim can include a lip that extends radially such that the lip defines an outer circumferential edge of the opening of the shaker cup. In some configurations, a distal surface of the projection can be configured to form a face seal with a top surface of the lip of the shaker cup.

A method for shaking a beverage can include placing one or more ingredients in a shaker cup, positioning a serving cup on top of the shaker cup to seal the shaker cup, wherein the serving cup is less rigid than the shaker cup, shaking the shaker cup and the serving cup together, removing the shaker cup from the serving cup, and serving the beverage in the serving cup.

In some aspects, the beverage is a tea or coffee beverage. In some aspects, the shaker cup comprises plastic, glass, or metal. In some aspects, the serving cup comprises plastic or paper.

A method for preparing a beverage can include placing one or more ingredients in a shaker cup, positioning a first serving cup of a first size or a second serving cup of a second size on top of the shaker cup to seal the shaker cup, wherein the first size is different from the second size, shaking the shaker cup and the first or second serving cup together, removing the shaker cup from the first or second serving cup, and serving the beverage in the first or second serving cup.

In some aspects, the method includes positioning the first serving cup in an inverted position when the first serving cup is received by the shaker cup, where, in the inverted position, an open end of the serving cup is positioned beneath a closed end of the serving cup. In some aspects, shaking the shaker cup and the first or second serving cup together includes positioning the shaker cup in an upright position and the first or second serving cup in an inverted position. In some aspects, the method can include inverting the shaker cup and the first or second serving cup together such that the shaker cup is in an inverted position and the first or second serving cup is in an upright position. In some aspects, the method further includes placing a lid on the first or second serving cup. In some aspects, shaking the shaker cup and the first or second serving cup together comprises forming a foam head with a height between 0.25 inches to 2 inches.

A shaker cup can include a body defining a first interior, a rim defining an opening, a first ridge of a first ridge diameter positioned below the rim, and a second ridge of a second ridge diameter positioned below the first ridge. The first ridge can be configured to receive a first serving cup of a first size. The second ridge can be configured to receive a second serving cup of a second size. The first ridge diameter can be larger than the second ridge diameter. The shaker cup can include a solid fill indicia, indicating a volume of granular solid for a beverage recipe. The shaker cup can include a liquid fill indicia, indicating a volume of liquid for the beverage recipe.

In some configurations, the first ridge can include a first planar surface that is concentric to the rim. The second ridge can include a second planar surface that is concentric to the first ridge. In some configurations, the shaker cup can include an indicia of volume size for the beverage recipe, wherein the indicia of volume size is part of or connected to a horizontal line of the solid fill indicia or the liquid fill indicia. In some examples, the solid fill indicia can include an opaque portion and the liquid fill indicia can include a clear portion. In some configurations, the liquid fill indicia overlaps with the solid fill indicia. In some configurations, the solid fill indicia can be positioned above the liquid fill indicia. In some configurations, the liquid fill indicia can include a plurality of level indicators. In some examples, a height or a length of each of the plurality of level indicators can vary based on proportions of ingredients of at least one beverage recipe. In some configurations, the plurality of level indicators can be in a stacked configuration. In some configurations, the shaker cup can include an indicia of volume size of a beverage recipe. In some configurations, the indicia of volume size can indicate a total volume of liquid and solid ingredients for a beverage recipe. In some configurations, the solid fill indicia can be a first solid fill indicia of a first series of indicia and the liquid fill indicia can be a first liquid fill indicia of the first series of indicia. The first series of indicia can indicate volumes of ingredients for a first size of beverage. In some configurations, the shaker cup can include a second series of indicia to indicate volumes of ingredients for a second size of beverage. In some configurations, the second series of indicia can include a second solid fill indicia and a second liquid fill indicia. In some configurations, the second liquid fill indicia can be proportionally taller than the first liquid fill indicia. In some configurations, the second solid fill indicia can be proportionally taller than the first solid fill indicia.

In another aspect a shaker cup and serving cup assembly can include a shaker cup and a first serving cup of a first size and a second serving cup of a second size. The shaker cup can include a body defining a first interior, a rim defining an opening, a first ridge of a first ridge diameter positioned below the rim, and a second ridge of a second ridge diameter positioned below the first ridge. The first ridge diameter can be larger than the second ridge diameter. The first size and the second size can be different. The first ridge of the shaker cup can be configured to receive the first serving cup. The second ridge of the shaker cup can be configured to receive the second serving cup. The shaker cup can include a solid fill indicia, indicating a volume of granular solid for a beverage recipe, and a liquid fill indicia, indicating a volume of liquid for the beverage recipe.

In some configurations, the first serving cup can be configured to be inverted such that an open end of the first serving cup is positioned below a closed end of the first serving cup when the first serving cup is received by the shaker cup. In some configurations, the shaker cup can include a first material. The first serving cup and the second serving cup can include a second material. The first material can be more rigid than the second material.

In another aspect, a method for preparing a beverage can include placing one or more ingredients in a shaker cup and positioning a first serving cup of a first size or a second serving cup of a second size on top of the shaker cup to seal the shaker cup. The first size can be different from the second size. The method can further include placing a granular solid and a liquid in the shaker cup to an indicia, shaking the shaker cup and the first or second serving cup together, removing the shaker cup from the first or second serving cup, and serving the beverage in the first or second serving cup.

In some configurations, placing the granular solid and the liquid in the shaker cup to the indicia can include placing the granular solid in the shaker cup up to a first indicia and placing the liquid in the shaker cup up to a second indicia. In some configurations, placing the granular solid and the liquid in the shaker cup to the indicia can include placing the liquid in the shaker cup up to a first indicia and placing the granular solid in the shaker cup up to a second indicia. In some configurations, the method can include positioning the shaker cup and the first or serving cup together such that the shaker cup is positioned above the first or second serving cup prior to removing the shaker cup from the first or second serving cup. In some configurations, the method can include positioning the shaker cup and the first or serving cup together such that the first or second serving cup is positioned above the shaker cup prior to removing the shaker cup from the first or second serving cup. In some configurations, the method can include pouring the beverage from the shaker cup into the first or second serving cup prior to serving the beverage in the first or second serving cup.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1 illustrates an embodiment of a shaker cup.

FIG. 2 illustrates a side view of the shaker cup of FIG. 1.

FIG. 3 illustrates a cross-sectional view of the shaker cup of FIG. 1.

FIG. 4 illustrates a shaker cup and beverage cup assembly.

FIG. 5 illustrates the shaker cup with two beverage cups.

FIG. 6 illustrates a close up view of a portion of FIG. 5.

FIG. 7 illustrates another embodiment of a shaker cup.

FIG. 8 illustrates a side view of the shaker cup of FIG. 7.

FIG. 9 illustrates a shaker cup and beverage cup assembly.

FIG. 10 illustrates a lid for a shaker cup.

FIG. 11 illustrates a cross-sectional view of the lid of FIG. 10.

FIG. 12 illustrates a cross-sectional view of the lid and shaker cup assembly.

FIG. 13 illustrates a close up view of a portion of FIG. 12.

FIG. 14 illustrates a perspective view of a shaker cup.

FIG. 15 illustrates a layout of the indicia of measurement on the shaker cup shown in FIG. 14.

FIG. 16 illustrates a perspective view of another embodiment of a shaker cup.

FIG. 17 illustrates a layout of the indicia of measurement of the shaker cup shown in FIG. 16.

### DETAILED DESCRIPTION

Various beverage preparation systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the spirit and scope of the disclosure. Indeed, this disclosure is not limited to the particular embodiments shown but is instead to be accorded the widest scope consistent with the principles and features that are disclosed or suggested herein. For example, many of the embodiments are described in the context of preparing a beverage including shaking. However, certain features and aspects of the disclosure may also have utility in preparing other liquids, such as sauces or dressing.

The process of shaking a beverage can be time consuming and inefficient. The process can include placing the ingredients into a vessel. The vessel may then be closed before the vessel is shaken. The vessel can be sealed when closed to prevent leaking of the beverage from the vessel during shaking. The sealing process can be ineffective or unreliable. After shaking, the vessel can be opened. The beverage can then be transferred from the vessel into a container for serving the beverage.

There is a need for an improved beverage shaker assembly. Beverage shaker assemblies generally use two shaker cups to prepare and shake a beverage. Beverage shaker assemblies can be messy and require frequent cleaning of the shaker assembly as well as preparation surfaces due to leaking seals between the shaker cups. The beverage shaker assemblies can also be inefficient in preparing beverages because the shaker assemblies may not be appropriately sized for the beverage being prepared. This can lead to preparing a greater quantity of the beverage than was ordered. Additional inefficiencies occur when transferring a shaken beverage from the shaker assembly into a serving cup.

The following description is directed towards an improved beverage preparation system. The improved beverage shaker assembly can form a watertight seal with various sizes of serving cups. This can allow a beverage placed within the shaker assembly to be thoroughly mixed without spilling the beverage. Additionally, the improved beverage shaker assembly can utilize a serving cup to shake the beverage. The efficiency of beverage preparation is improved by using a serving cup to shake the beverage by removing the step of transferring the shaken beverage from the shaker assembly into the serving cup. This can reduce the time required to make the beverage, remove the spill risk of transferring the beverage from the shaker assembly into the serving cup, and reduce the number of shaker assembly components requiring cleaning between uses. Additionally, the use of the improved shaker assembly can also increase beverage preparation efficiency by producing accurate beverage volume yields by shaking the beverage with an appropriately sized serving cup while simultaneously producing a well shaken beverage.

The shaker assembly may also be equipped with a lid which can form a watertight seal with the shaker assembly. This can advantageously allow for flexibility in preparing beverages that may be served in re-usable containers, for example, if a customer brings in their own reusable serving cup.

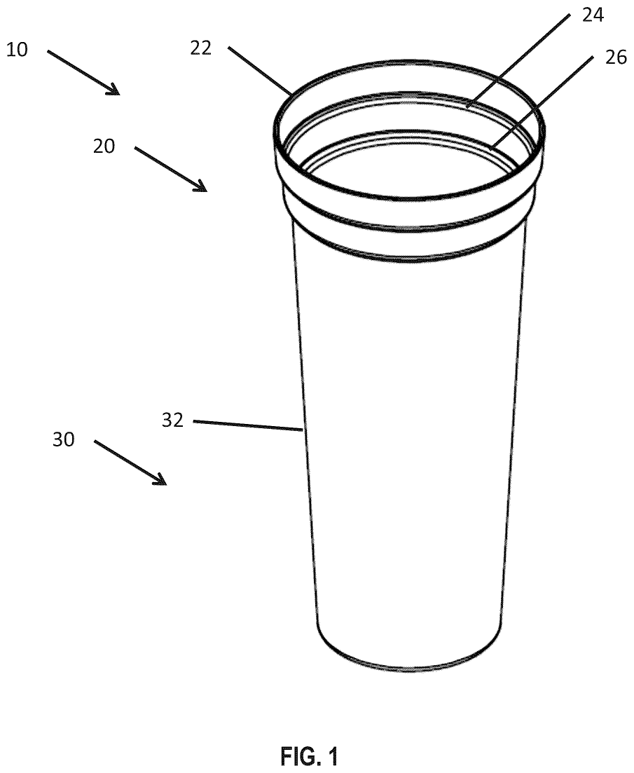

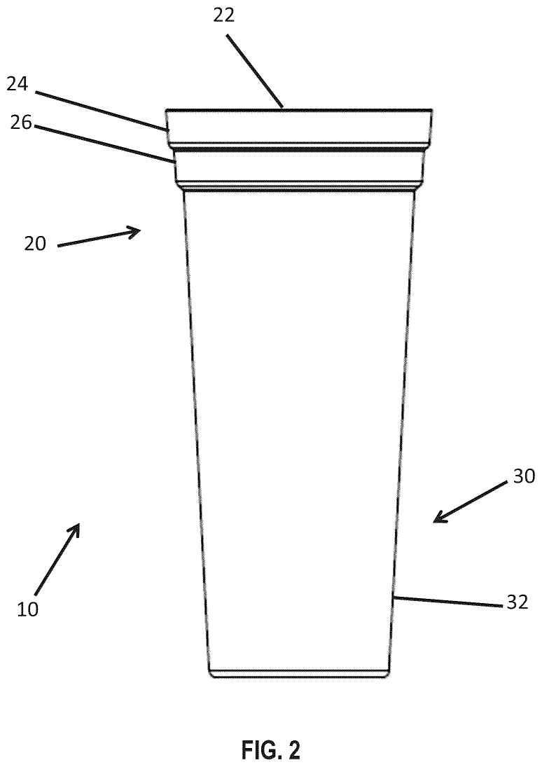

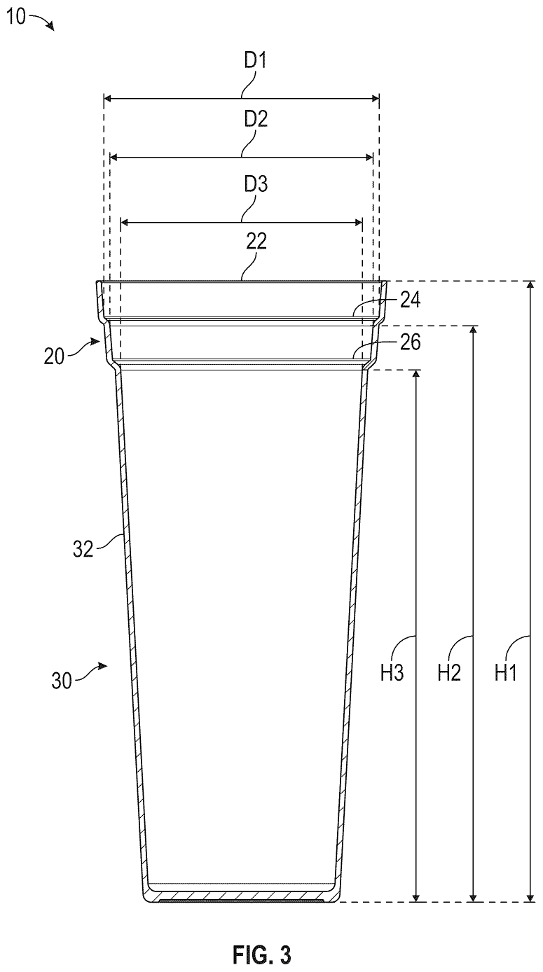

FIGS. 1-3 illustrate a shaker cup 10 for a shaker cup and cup assembly. The shaker cup 10 can be configured to engage with multiple cup sizes. The shaker cup 10 can be configured to engage with a drinking cup. This advantageously allows the beverage to be shaken in the same cup for serving and drinking. The serving cup can act to seal the shaker cup 10 and the assembly can be shaken to shake the beverage. In other examples, the shaker cup 10 can seal the serving cup. Once the beverage is shaken in the assembly, the beverage can be positioned in the serving cup. The shaker cup 10 can then be removed from the serving cup and replaced with a lid for drinking. This can advantageously beverage to be shaken and served in the same cup.

The shaker cup 10 can include a top portion 20 and a bottom portion 30. The body 32 of the cup 10 can be at the bottom portion 30 of the cup 10. The rim 22 of the cup 10 can be at the top portion 20 of the cup 10. The rim 22 can define the opening of the cup 10. The shaker cup 10 can include a series of ridges of various sizes at the top portion 20 of the cup 10. The ridges can be a series of concentric ridges. As shown in FIGS. 1-3, the cup 10 can include two ridges 24, 26 of different diameters and at different levels along the length of the cup. The two ridges can include a first ridge 24 and a second ridge 26. Each ridge 24, 26 can each be a planar surface. The first ridge 24 and the second ridge 26 can be concentric planar surfaces. The rim 22, the first ridge 24, and the second ridge 26 can be concentric to one another.

The inner diameter of each ridge 24, 26 and the rim 22 can decrease in a vertical direction, from the top end towards the bottom end of the cup 10. The rim 22 can have the largest inner diameter compared to the inner diameter of the first ridge 24 and the inner diameter of the second ridge 26. The first ridge 24, positioned between the second ridge 26 and the rim 22, can have a smaller inner diameter than the inner diameter of the rim 22. The second ridge 26 can have the smallest inner diameter compared to the inner diameter of the rim 22 and the inner diameter of the first ridge 24. In this manner, the rim 22, the first ridge 24, and the second ridge 26 can form a stepped profile. The stepped profile can decrease in size along the length of the cup from the open end towards the closed end. As shown in FIGS. 1-3, the body 32 can be tapered such that the diameter changes throughout the length of the body 32. The ridges 24 and 26 can be molded into the inner surface of the body 32 forming a stepped profile and the outer surface of the body 32 can have a smooth profile with a constant slope. As shown in FIGS. 1-3 the ridges 24 and 26 can be molded into the body 32 forming a stepped profile in both the inner surface and the outer surface of the body 32. The body 32 can include constant or nearly constant wall thickness throughout the cup 10. The body 32 can include varied wall thicknesses throughout the cup 10. The wall thickness of the body 32 can decrease from the second ridge 26 to the first ridge 24. As shown in FIGS. 1-3, the inner diameter of the body 32 can decrease in a vertical direction, from the top end towards the bottom end of the cup 10. In other examples, the inner diameter of the body 32 can increase in a vertical direction, from the top end towards the bottom end. In other examples, the body 32 can be cylindrical such that the diameter is consistent throughout the length of the body 32. As shown in FIGS. 1-3, the largest inner diameter of the body 32 can be at the top of the body 32. The largest diameter of the body 32 can be the same or smaller than the inner diameter of the second ridge 26.

In some examples, the rim 22 can have an inner diameter D1. D1 can be between 4 inches to 5 inches, and in some embodiments between 4.0 inches to 4.2 inches. The first ridge 24 can have an inner diameter D2. D2 can be between 3 inches to 4 inches, and in some embodiments between 3.5 inches to 4 inches. The second ridge 26 can have an inner diameter D3. D3 can be between 3 inches to 4 inches, and in some embodiments between 3.4 inches to 3.8 inches. The body 30 can slope outward from D3 to D2 and from D2 to D3. The outward slope from D3 to D2 can be between 1 and 6 degrees, and in some embodiments between 3 and 4 degrees. The outward slope from D2 to D1 can be between 1 and 6 degrees, and in some embodiments between 3 and 4 degrees. The first ridge 24 can be extend inward at an angle between 115 and 160 degrees from the slope of the wall to form the ridge 24 and reduce the inner diameter from D1 to D2. The second ridge 26 can be extend inward at an angle between 115 and 160 degrees from the slope of the wall to form the ridge 26 and reduce the inner diameter from D2 to D3. In some examples, the inner diameter of the top portion of the body 32 can be between 3 inches to 4 inches, and in some embodiments between 3.5 inches to 4 inches. The shaker cup 10 can have a total height of H1. H1 can be between 8 inches to 10 inches, such as between 9 inches to 9.5 inches. The shaker cup 10 can have a height H2 from the bottom of the first ridge 24 to the bottom of the cup 10. H2 can be between 7.5 inches to 9.5 inches, such as between 9 inches and 8 inches. The shaker cup 10 can have a height H3 from the bottom of the second ridge 26 to the bottom of the cup 10. H3 can be between 7 inches to 9 inches, such as between 8.5 inches and 7.75 inches.

In some examples, the overall length or height of the shaker cup 10 can be between 6 inches to 9 inches, and in some embodiments between 8 inches and 9 inches. In some examples, the height or length of the shaker cup 10 can be between 8 inches and 8.5 inches.

In other examples, the cup 10 can include at least two ridges of various diameters. In some examples, the cup 10 can include 1, 3, 4, 5, or more ridges of various diameters. Each ridge having a different diameter, which can advantageously allow the shaker cup 10 to receive a variety of serving cups of different sizes. Specifically, the shaker cup 10 can fit a variety of diameters of serving cup openings. The number of ridges of the shaker cup 10 can correspond to the number of sizes of cups that the shaker cup 10 can engage with. For example, the illustrated shaker cup 10 in FIGS. 1-3 has two ridges and is therefore configured to fit with two sizes of openings of serving cups. In another example, a shaker cup having three ridges may be configured to fit with three sizes of openings of serving cups. Serving cups having different volumes may have the same size opening. For example, a serving cup with a larger volume may have a larger diameter opening and a serving cup with a smaller volume may have a smaller diameter opening. Serving cups having different volumes may have the same diameter opening. In some examples, a shaker cup having two ridges may be configured to fit with 2, 3, 4, 5, or 6 different volumes of serving cups.

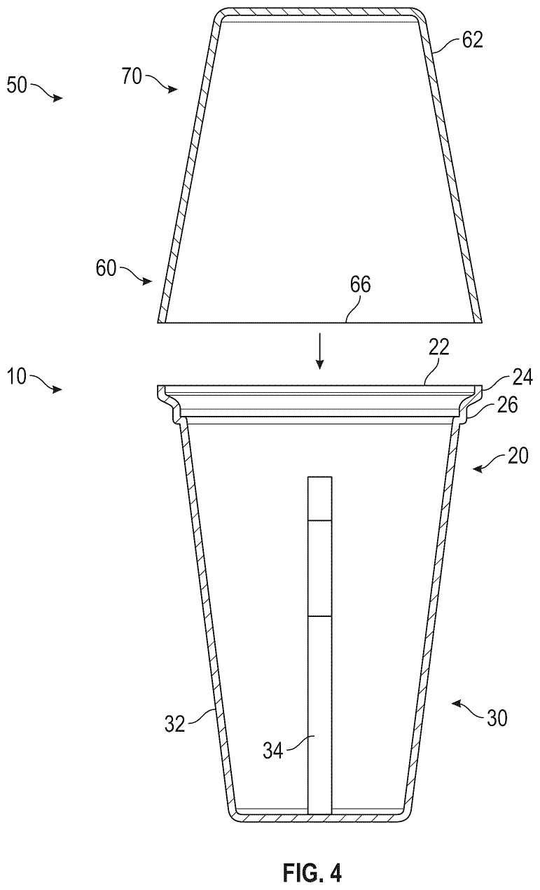

FIG. 4 illustrates an embodiment of a shaker cup 10 and serving cup 50 assembly. The shaker cup 10 can be configured to receive a serving cup 50. The shaker cup 10 can be similar to the shaker cup 10 shown in FIG. 1, except for the window 34. As shown in FIG. 4, the body 32 of the shaker cup 10 can include a window 34 that allows a user to see a level of liquid positioned within the shaker cup 10. The window 34 can include one or more markers that show measurements of liquid within the cup 10. As shown in FIG. 4, the shaker cup 10 can be configured to receive a serving cup 50. The serving cup 50 can be inverted such that the open end is facing downward or such that the open end at the first portion 60 is positioned at the bottom and the closed end at the second portion 70 is positioned at the top. The open end 60 of the serving cup 50 can be positioned adjacent to the top portion 20 of the shaker cup 10. The rim 66 of the open end of the serving cup 50 can be positioned against the one of the first ridge 24 or the second ridge 26 of the shaker cup 10. This can allow the serving cup 50 and the shaker cup 10 to form a seal. The body 32 of the shaker cup 10 can define a first interior or cavity. The body 62 of the serving cup 50 can define a second interior or cavity. When the serving cup 50 and shaker cup 10 are engaged to form a seal, the first interior of the shaker cup 10 and the second interior of the serving cup 50. This can allow the interior of the shaker cup 10 and the interior of the serving cup 50 to form an enclosed interior. The beverage can be shaken within the enclosed interior.

The enclosed interior provided between the components can be sized and shaped to allow for significant turbulence of the contents positioned within the enclosed interior. Due to the size of the enclosed interior, the user can fully shake the assembly to shake the beverage. This can provide more efficient mixing of the beverage over swirling or mixing. The enclosed interior can also advantageously allow the beverage to be shaken efficiently such that the time and effort required to shake the beverage is reduced. In some examples, the shaker cup 10 can have a height H1 between 8 inches to 12 inches, and in some examples between 9 inches to 10 inches. In some examples, the shaker cup 10 can have a maximum width or diameter D1 of 3 inches to 6 inches, and in some examples between 4 inches to 5 inches. In some examples, the turbulence achieved only requires between 3 to 5 shakes to achieve adequate mixing of the beverage such that a frothy top layer is formed on the beverage. In some examples, the shaken beverage has a foam head or layer of at least between 0.25 inches and 2 inches in height. The use of shaker cup 10 as described herein to prepare a beverage is particularly useful to prepare a tea or coffee beverage (that is, a beverage formed, at least in part, from coffee or tea component).

In some examples, the shaker cup 10 can include a gasket on an upper surface of the ridges. The gasket can seal the rim 66 of the serving cup 50 and the corresponding ridge 24, 26 of the shaker cup 10. The gasket can be made of silicone or any soft material that can facilitate sealing. In some examples, the shaker cup 10 can exclude the silicone gasket such that the ridges 24, 26 are made of the same material as the remainder of the cup 10 and directly contact the rim 66 of the serving cup 50.

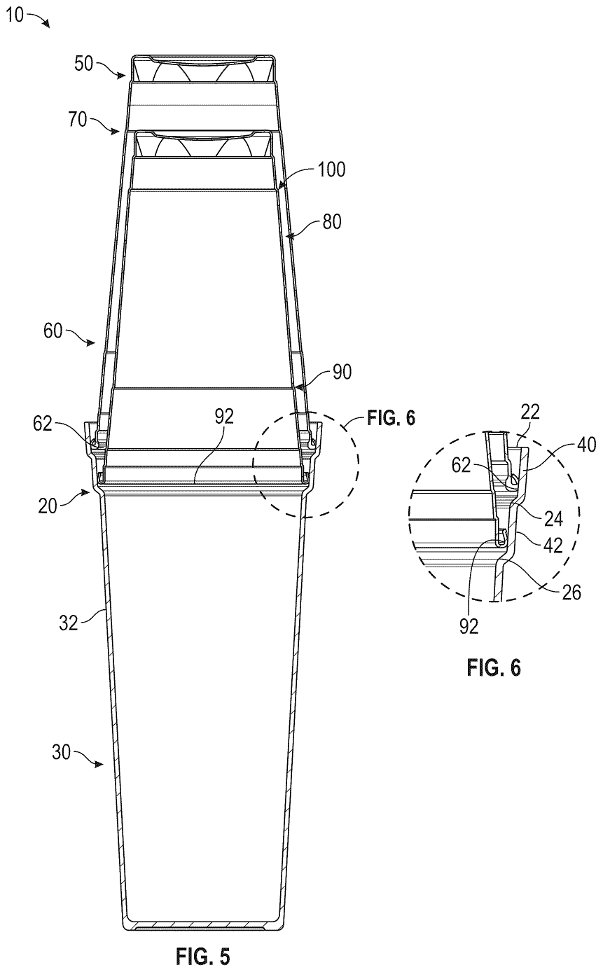

FIG. 5 illustrates the shaker cup 10 receiving two serving cups 50, 80. FIG. 6 illustrates a close up view of a portion of the two serving cups 50, 80 each engaged by a portion of the shaker cup 10. The shaker cup 10 can be configured to receive two different sizes of serving cups 50, 80. Although the shaker cup 10 in FIGS. 5 and 6 is shown with two serving cups 50, 80, the shaker cup 10 can be used with only one of the serving cups 50, 80. The second serving cup 80 can have a first open end 90 and a second closed end 100. The second serving cup can have a rim 92 at the first open end 90. The rim 62 of the first cup 50 can be received and engage with the first ridge 24 of the shaker cup 10. The rim 92 of the second cup 80 can be received and engage with the second ridge 26 of the shaker cup 10. The rim 62 of the first serving cup 50 can have a similar outer diameter to the diameter of the first ridge 24. The rim 92 of the second serving cup 80 can have a similar diameter to the diameter of the second ridge 26. The diameter of the rim 62 of the first serving cup 50 can be larger than the diameter of the rim 92 of the second serving cup 80.

The ingredients for a beverage can be positioned in the interior of the shaker cup 10. One of the serving cups 50, 80 can be affixed to a top of the shaker cup 10 to create a seal. In some examples, the first serving cup 50 can be affixed to a top of the shaker cup 10 and positioned against the first ridge 24 of the shaker cup 10. When sealed, the interior of the shaker cup 10 and the interior of the serving cup 50 can together define an interior enclosed space. The assembly of the shaker cup 10 and the serving cup 50 can be shaken together to move and mix the beverage within the interior enclosed space. While shaking, the shaker cup 10 can remain in a substantially upright position and the serving cup 50, 80 can be in a substantially upside-down position. While shaking, the shaker cup 10 and the serving cup 50, 80 can be in a substantially horizontal position. Once shaken, the shaker cup 10 and serving cup 50, 80 can be inverted such that the shaker cup 10 is at the top in an upside-down position and the serving cup 50, 80 is on the bottom in an upright position. In the upright position, the serving cup 50 can be positioned such that the closed end 50 can be positioned beneath the open end 60. The shaker cup 10 can then be removed from the serving cup 50. The serving cup 50 with the shaken beverage positioned therein can then be served to a customer. In some examples, the shaker cup 10 and serving cup 50, 80 can be positioned such that the serving cup 50, 80 can be in an inverted position above the shaker cup 10. The shaker cup 10 can remain upright and the inverted serving cup 50, 80 can be removed from the shaker cup 10. The shaken beverage can then be poured from the shaker cup 10 into the serving cup 50, 80 for serving to a customer.

The diameter of each of the ridges 24, 26 can be configured to receive a rim of a serving cup of a respective size. The step profile of the ridges 24, 26 and the rim 22 advantageously provides both a face seal and a radial seal. For example, as shown in FIG. 6, when the first ridge 24 receives the first cup 50 of a corresponding diameter, the planar surface of the first ridge 24 can form a face seal with the top or planar surface of the rim 62 of the serving cup. Simultaneously, the inner circumferential surface of the rim 22 can form a radial seal with the outer circumferential surface of the rim 62 of the serving cup 50. The inner surface of the first sidewall 40 can form a radial seal with the outer circumferential surface of the rim of the first serving cup 50. The inner surface of the second sidewall 42 can form a radial seal with the outer circumferential surface of the rim of the second serving cup 80. Similarly, the second ridge 26 can receive the second serving cup 80 such that the second ridge 26 provides both a radial seal and a face seal between the second serving cup 80 and the shaker cup 10.

As shown in the cross-sectional view illustrated in FIG. 6, the first ridge 24 and the second ridge 26 can be a concentric planar surface that extends substantially perpendicular to the inner surface of the sidewalls of the shaker cup 10. A first sidewall 40 can extend between a rim 22 and the ridge 24. A second sidewall 42 can extend between the first ridge 24 and the second ridge 26. In some examples, the first ridge 24 can be positioned at a first angle relative to the first sidewall 40 and the second ridge 26 can be positioned at a second angle relative to the second sidewall 42. In some examples, the first and second angles can each be at least 90 degrees. In some examples, the first and second angles can each be at least 100 degrees, 110 degrees, 120 degrees, or 130 degrees. In some examples, the first and second angles can each be between 90 degrees to 145 degrees and in some embodiments between 115 degrees to 145 degrees. In some examples, the first and second angles can advantageously allow the first and second sidewalls 40, 42 to provide a radial seal to the respective serving cup while still enabling the respective serving cup to easily fit within the first and second sidewalls 40, 42. The shaker cup 10 and the serving cup 50, 80 be assembly quickly in this manner. The shaker cup 10 and the serving cup 50, 80 can also be assembled such that the longitudinal axis of each of the shaker cup 10 and the serving cup are aligned, such that neither component is tilted. The shaker cup 10 can contact the respective serving cup with adequate friction and support to maintain the assembly with only the user holding both components together while shaking. The shaker cup 10 and the serving cup can be assembled to form a vacuum to facilitate the seal between the shaker cup 10 and the serving cup 50, 80. The user is not required to tilt either component or to forcefully slam the shaker cup 10 and the respective serving cup together to form a seal.

The shaker cup 10 can include a rigid material, such as a hard plastic, glass, or metal. The shaker cup 10 can be substantially made of the rigid material. The shaker cup 10 can be reusable and resilient to withstand repeated use and cleaning. The shaker cup 10 can also be resilient to temperature variations and maintain its shape in high and low temperature environments. The serving cup 50, 80 can include less rigid materials, such as thinner or softer plastic or paper, or thin-walled metal. The serving cup 50, 80 can be substantially made of the less rigid material. The serving cup 50, 80 can be less rigid than the shaker cup 10. The serving cup 50, 80 can be a disposable cup and/or a single use cup. The serving cup 50, 80 may be a reusable cup. Due to the shape, size, and rigidity of the shaker cup 10 as described herein, the shaker cup 10 can advantageously be used with serving cups 50, 80 that are less rigid. The shaker cup 10 can be resilient, allowing the diameter of the shaker cup 10 to deform when squeezed. The serving cups 50, 80 may be resilient, allowing the diameter of the serving cup 50, 80 to deform when squeezed. The serving cups 50, 80 may deform with less force than the shaker cup 10. Advantageously, the serving cups 50, 80 may be squeezed to deform and release the seal between the serving cups 50, 80 and the shaker cup 10. As described herein, this allows the beverage to be prepared and shaken in the serving cup 50, 80 with the shaker cup 10 and then served in the same serving cup 50, 80. This reduces the number of steps required, time and number of components to prepare a beverage. The use of hard plastic can also advantageously prevent the shaker cup 10 from overheating. This advantageously allows the shaker cup 10 to be used with hot or warm beverages without causing discomfort or injury to the user holding the shaker cup 10. The use of hard plastic can also advantageously prevent the shaker cup 10 from becoming too cold. This advantageously allows the shaker cup 10 to be used with iced beverages without causing discomfort or injury to the user holding the shaker cup 10.

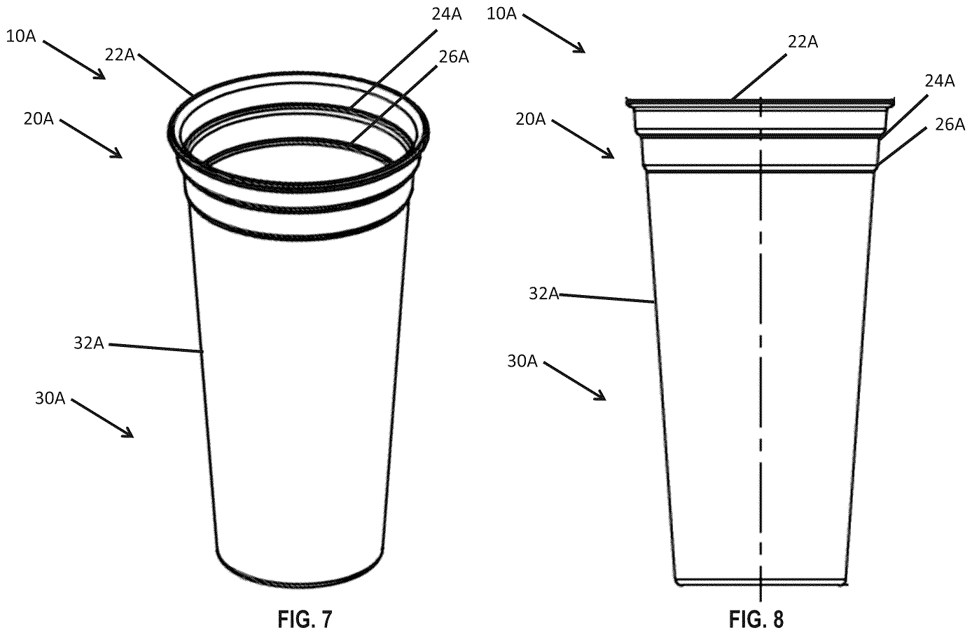

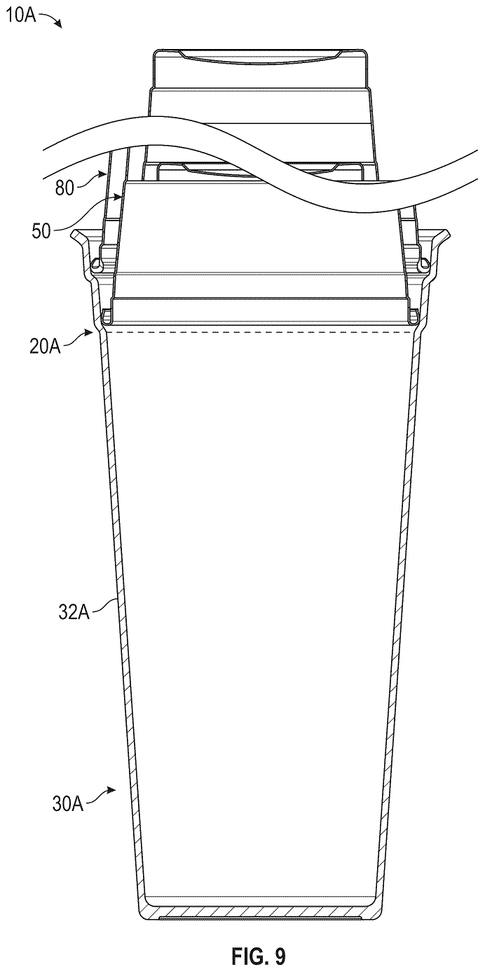

FIG. 7 illustrates another embodiment of a shaker cup 10A. FIG. 8 illustrates a side view of the shaker cup 10A of FIG. 7. FIG. 9 illustrates a shaker cup and beverage cup assembly. FIG. 9 shows the embodiment of the shaker cup 10A of FIGS. 7-8 used as a shaker cup with serving cups 50, 80. Some of the features of the shaker cup 10A are similar to features of the shaker cup 10 in FIGS. 1-6. Thus, reference numerals used to designate the various components of the shaker cup 10A are identical to those used for identifying the corresponding components of the shaker cup 10 in FIGS. 1-6, except that an “A” has been added to the numerical identifier. Therefore, the structure and description for the various features of the shaker cup 10 in FIGS. 1-6 are understood to also apply to the corresponding features of the liner 10A in FIGS. 7-9, except as described below.

The shaker cup 10A differs from the shaker cup 10 in that the outer rim 22A of the open end of the top portion 20A of the cup 10A has a flange or lip. The lip can extend around or define the outer circumferential edge of the opening of the top portion 20A of the cup 10A. The lip can extend radially such that the lip defines an outer circumferential edge of the opening of the shaker cup 10A. The lip can extend in a radial direction from the outer circumferential edge of the top portion 20A of the cup 10A. In some examples, the lip or flange can extend radially or have a width of at least between 2 mm and 4 mm and in some embodiments at least 3 mm. In some examples, the height or thickness of the flange or lip can be at least between 2 mm and 4 mm and in some embodiments at least 3 mm.

In some examples, the outer diameter of the rim 22A including the lip can be between 4 inches to 5 inches and in some embodiments between 4.2 inches to 4.6 inches. The inner diameter of the rim 22A can be between 4 inches to 5 inches, and in some embodiments between 4.0 inches to 4.2 inches. In some examples, the inner diameter of the first ridge 24A can be between 3.5 inches to 4 inches, and in some embodiments between 3.8 inches to 4 inches. In some examples, the inner diameter of the second ridge 26A can be between 3 inches to 4 inches, and in some embodiments between 3.4 inches to 3.8 inches. In some examples, the inner diameter of the top portion of the body 32A can be between 3 inches to 4 inches, and in some embodiments between 3.5 inches to 4 inches. In some examples, the overall length or height of the shaker cup 10A can be between 6 inches to 9 inches, and in some embodiments between 8 inches and 9 inches. In some examples, the height or length of the shaker cup 10A can be between 8 inches and 8.5 inches.

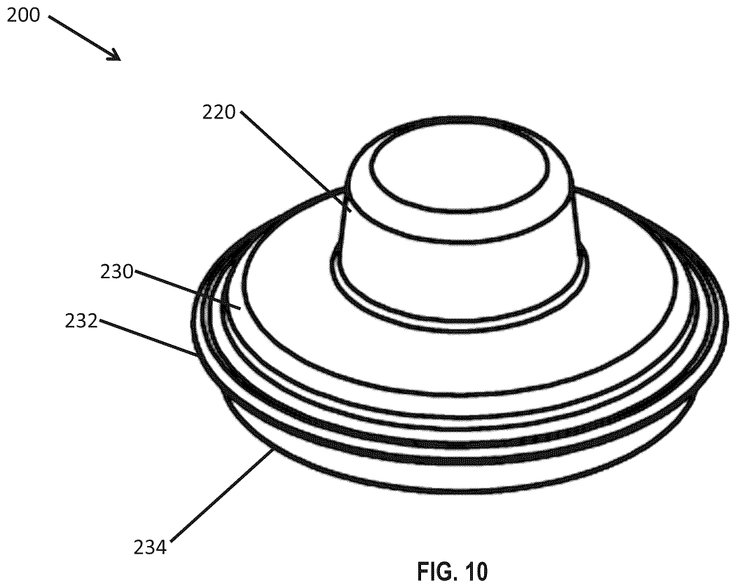

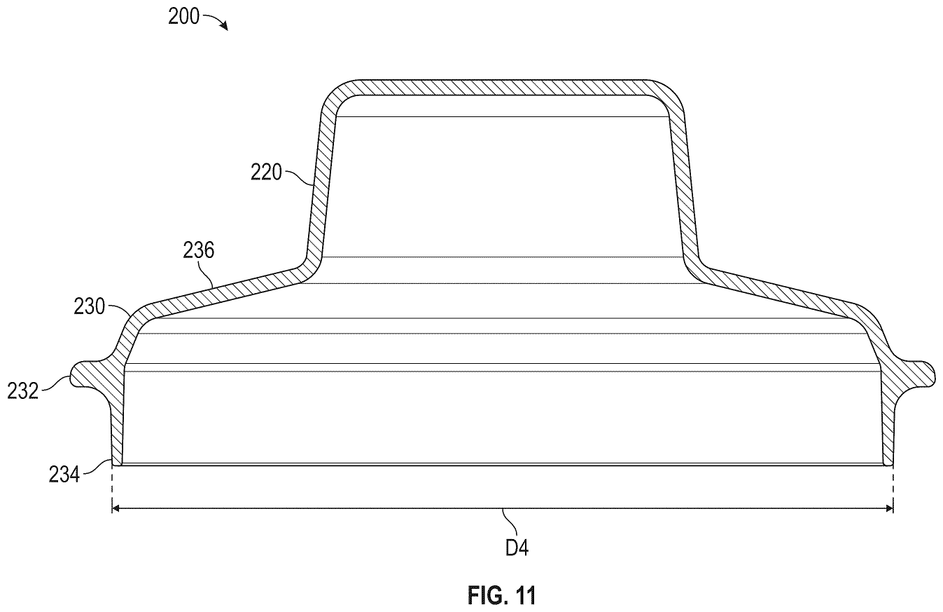

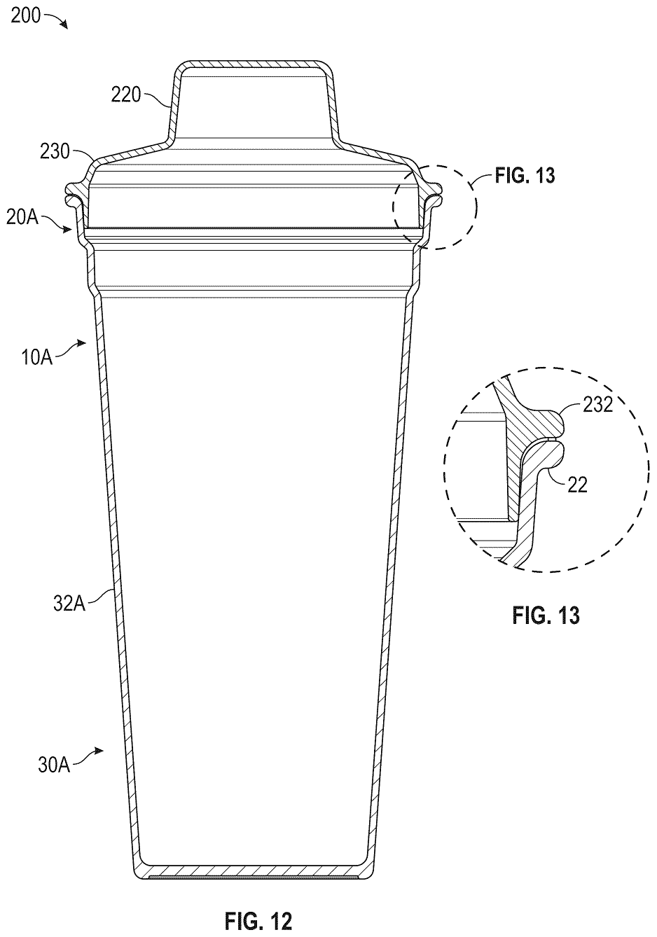

FIG. 10 illustrates a lid 200 that is configured to be used with a shaker cup. FIG. 11 illustrates a cross-sectional view of the lid of FIG. 10. FIG. 12 illustrates a cross-sectional view of the lid and shaker cup assembly. FIG. 13 illustrates a close up view of a portion of FIG. 12. In some examples, instead of using a serving cup as a top portion to close the opening of the shaker cup, the lid 200 can be used. This advantageously allows the shaker cup to be used in other configurations, such as without the serving cup. The lid 200 can include a handle 220 at a top portion of the lid 200 and a base 230 at a bottom portion of the lid 200. The handle 220 can be configured to be gripped by a user to position the lid 200, such as sealing the lid 200 to a shaker cup or unsealing the lid 200 from the shaker cup. The handle 220 can be knob shaped or another shape that conveniently allows a user to grip and maneuver the handle 220. The handle 220 can extend from the base 230 in a proximal direction. The base 230 can have a dome shape. The base 230 can include a projection or skirt 232 that extends from an outer surface of the base 230. The projection or skirt 232 can extend radially from an outer circumferential surface of the base 230. The projection or skirt 232 can be positioned along a central portion of the outer surface of the base 230. The top or proximal portion 236 of the base 230 can be positioned above or be located proximally from the projection or skirt 232. The bottom or distal end 234 of the base 230 can be positioned below or be located distally from the projection or skirt 232. The bottom or distal end 234 include a circumferential wall. The base 230 can be hollow such the base 230 defines an interior recess, which can increase the interior space of the assembly for the beverage to be shaken. In some examples, the handle 220 can also be hollow and define an interior recess. The interior recess of the handle 220 can be connected to the interior recess of the base 230.

In some examples, the lid 200 can be configured to fit with the shaker cup 10 of FIGS. 1-3. In some examples and as illustrated in FIG. 12, the lid 200 can be configured to fit with the shaker cup 10A of FIGS. 7-8. The bottom or distal end 234 of the base 230 can have an outer diameter H4 that is configured to fit within the opening of the shaker cup 10A. The outer diameter H4 can be between 5 inches and 3 inches, for example, between 3.5 and 4.25 inches. The projection or skirt 232 can have a larger outer diameter than the bottom end 234 of the base 230. The projection or skirt 232 can have at least the same size diameter as the outer diameter of the open end of the shaker cup 10A. The projection or skirt 232 can be configured to be positioned against the lip of the rim 22A of the shaker cup 10A. In this manner, the projection or skirt 232 can facilitate the seal of the lid 200 and the cup 10A.

As shown in FIG. 12, the lid 200 can be affixed to a top of a shaker cup 10A to create a seal. The cup 10A, when closed with the lid 200, can then be shaken to prepare the drink. The lid 200 can be removed from the cup 10A. The lid 200 can fit within a mouth or opening of the cup 10A such that at least part of the distal end 234 of the lid 200 can fit within the cup 10A. The lid 200 can act as a plunger inside the cup 10A to seal the cup 10A for shaking. The material of the lid 200 can facilitate the sealing of the lid 200 with the cup 10A. The material can be soft to allow for both a face seal and a radial seal with the lid 200 and the cup 10A.

The configuration of the lid 200 provides both a face seal and a radial seal. For example, as shown in FIG. 12, when the distal end 234 fits into an opening of the shaker cup 10A of a corresponding diameter, the outer circumferential surface of the distal end 234 can form a radial seal with the inner surface of the opening of the cup 10A. Additionally, the bottom or distal surface of the projection or skirt 232 can form a face seal with the top surface of the lip of the rim 22A of the cup 10A. The projection or skirt 232 can also prevent the lid 200 from being pushed too far into the opening of the shaker cup 10A.

In some examples, the distal end 234 can be made of a material that can facilitate sealing. For example, the material can be soft enough to provide a snug fit within the opening of a cup. In some examples, the distal end 234 can be made of silicone or another type of elastomer. The remainder of the lid 200 can be made of the same material. The remainder of the lid 200 or at least the handle 220 can be made of a stiffer material, such as metal or plastic.

The process of measuring ingredients for a beverage recipe and placing them into a vessel can be time consuming and inefficient. The process can require various tools besides the vessel, such as measuring spoons, measuring cups, weighing scales or other tools. This can result in user error in the measurements, such as by incorrectly using the tools or in using the wrong tool for a particular ingredient. This can also result in awkward movements by the user in switching between tools as well as ingredients. The use of various tools to measure and place ingredients into a vessel can also require the user to reference a recipe, either from memory (which can result in errors) or from a written recipe (which can slow down the user). The use of various tools to measure and place ingredients into a vessel can also require the user to either remember or reference a recipe for the order of ingredients to be placed into a vessel.

There is a need for an improved beverage shaker cup with indicia for volumes of different ingredients for at least one beverage recipe. The improved beverage shaker cup with indicia for volumes of different ingredients can allow a user to create a beverage from a beverage recipe using the shaker cup and without the need for additional measuring tools. The improved beverage shaker cup with indicia can also advantageously provide recipes to a user such that the user would not have to memorize any or all of the beverage recipe, such as the ingredients, the order of ingredients, or the volumes of each of the ingredients. The improved beverage shaker cup with indicia can advantageously allow a user to create a beverage that includes both solid and liquid ingredients in the shaker cup without requiring measuring the solid ingredients separately from the liquid ingredients. The improved beverage shaker cup with indicia can also support multiple beverage recipes including beverage recipes for different types of drinks or beverage recipes for different sizes of drinks.

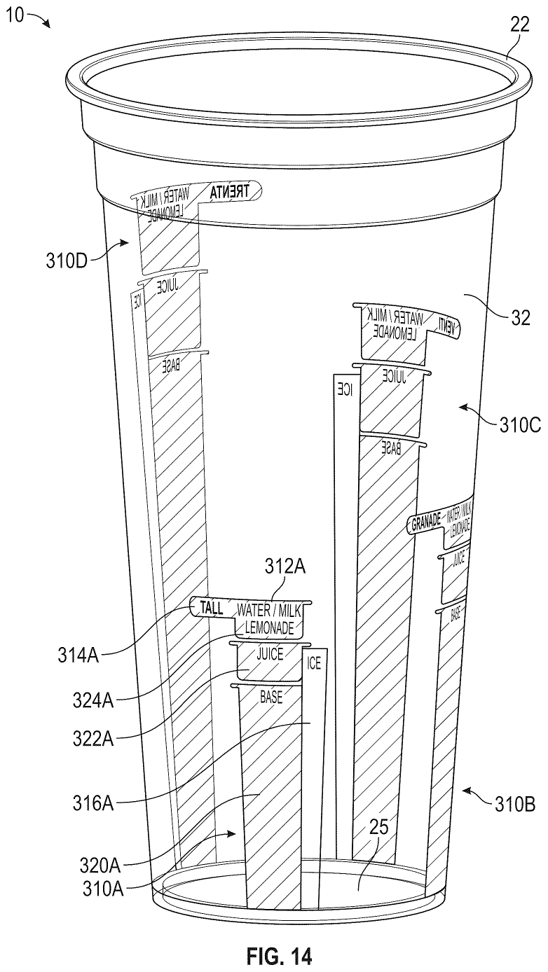

FIG. 14 illustrates a shaker cup 10 including a body 32. The shaker cup 10 can include any of the features of the shaker cups 10, 10A described above. A rim 22 can define the opening of the cup 10 and a base 25 can be positioned opposite from the rim 22. As illustrated, the shaker cup 10 can be clear or translucent.

The shaker cup 10 can include one or more series of indicia of measurement 310A, 310B, 310C, 310D. The one or more series of indicia of measurement can indicate a volume or amount of various ingredients for a beverage recipe to be made with the shaker cup 10. The series of indicia can enable amounts of various ingredients to be added to the shaker cup with the desired proportions for a beverage recipe. Each of the series of indicia of measurement can facilitate more than one beverage recipe. For example, one of the series of indicia can facilitate at least two beverage recipes with different ingredients. For example, a first series of indicia of measurement 310A can support a first beverage recipe, such as a coffee-based drink, and a second beverage recipe, such as a juice or tea-based drink. Using multiple series of indicia of measurements can also enable a recipe for a beverage to be scaled up or down for larger total beverage volumes while maintaining proper proportions. This can be advantageous to a user in relying on the series of indicia rather than using external measuring mechanisms or on unreliable techniques of measuring. This can also be advantageous to a user to avoid requiring calculations to change the size of the beverage. Moreover, the arrangement of the indicia within each of the one or more series of indicia of measurement can indicate an order to add ingredients for a beverage to result in the correct proportions of ingredients for a beverage and to facilitate mixing of the ingredients. For example, the order of ingredients added can prevent any ingredients from settling to the bottom of the shaker cup. The order of ingredients indicated by the indicia of measurement can also facilitate or avoid phase separation of the ingredients within the cup. For example, the shaker cup 10 can include a plurality of series of indicia of measurement, e.g., two series, three series, four series, five series, or more, or ranges therebetween any of the afore-mentioned values. Each of the series of indicia of measurement may correlate to a different beverage or food item. The different beverage may be a different type of beverage/food item or a different size of beverage/food item. This allows the same shaker cup to be used for different types or sizes of beverage/food items. Each series of indicia of measurements may extend along a longitudinal direction, e.g., perpendicular to the table when the cup is on the table. Each series of indicia of measurements may be circumferentially spaced apart around a circumference of the cup. When the series of indicia reflect different sizes of beverage/food items, a height of each series of indicia may generally increase around a circumference of the cup.

The shaker cup 10 can a first series of indicia of measurement 310A. The indicia of measurement 310A can begin at the base 25 and extend toward the rim 22 so that liquid ingredients (e.g., water, soda, tea, coffee, oil, juice, milk, lemonade, simple syrup, fruit puree, vinegar, honey, agave, yogurt, liquor, or milk alternatives) and solid ingredients (e.g., ice, chocolate, fruit, boba, nuts, syrup, oats, or protein powder) can be placed in the shaker cup 10 and can be measured by looking through the clear or translucent shaker cup 10 and identifying that the ingredient has reached the appropriate indicia of measurement 310A. The indicia of measurement 310A can include one or more solid fill indicia 316A, one or more liquid fill indicia 312A, and/or an indicia of volume size 314A. The solid and/or liquid fill indicia 316A, 312A may be generally arranged in a stacked configuration along a longitudinal direction of the cup. The solid and/or liquid fill indicia 316A, 312A can be arranged in a single column. The different indicia may be stacked in an order indicative of an order in which ingredients should be put into the cup. For example, the indicia closest to a bottom of the cup may be indicative of the first ingredient to be placed in the cup, and the indicia closest to a top of the cup may be indicative of the last ingredient to be placed in the cup. A height of each of the solid and/or liquid fill indicia 316A, 312A may be indicative of the amount of each ingredient to be placed in the cup. The height of each of the solid and/or liquid fill indicia 316A, 312A can vary based on the proportions of ingredients of the beverage recipe. Each indicia may have a generally opaque portion extending in a longitudinal direction of the cup and a fill line extending horizontally at the top of the generally opaque portion. The fill line being wider than the generally opaque portion to make it easier to measure a volume of ingredient. In some examples, the fill line may only extend circumferentially from the generally opaque portion in one direction (e.g., left or right), but in other configurations, the fill line may extend circumferentially from the generally opaque portion in both directions (e.g., left and right).

The solid fill indicia 316A and the liquid fill indicia 312A can be different opacities or include portions of different opacities, such as a first opacity (e.g. fully opaque or filled) and a second opacity (a reduced opacity) or no opacity (e.g. not opaque or clear). The unfilled indicia can instead have a border or horizontal fill line that remains opaque. In some examples, the solid fill indicia 316A can be not opaque while the liquid fill indicia 316A can be opaque. This can advantageously allow a user to quickly differentiate the type of ingredient (e.g. liquid versus solid) that corresponds to the indicia. In some examples, each of the indicia (such as each of the liquid fill indicia) can be a different color or alternating colors. In some examples, each of the indicia (such as each of the liquid fill indicia) can be different opacities (such as a gradient or alternating). Cross-hatching has been used to illustrate different shading that can be provided by the indicia (e.g., indicia of different opacities).

The indicia of volume size 314A may be located at the top of each series of indicia to indicate total volume. The indicia of volume size 314A may extend from, be part of, or connected to the fill line extending horizontally at the top of the solid or liquid fill indicia. For example, the indicia of volume size 314A can be a horizontal portion, such as a horizontal line or horizontal band, that is connected to or extends from the horizontal fill line at the top of the top liquid fill indicia 312A. In this manner, the indicia of volume size 314A can make it easier to measure the total volume of ingredients for a beverage recipe.

The one or more solid fill indicia 316A can indicate a volume of a granular solid (e.g., ice, chocolate, fruit, nuts, oats, or protein powder) which can be added to the shaker cup 10. Although FIG. 14 shows a single solid fill indicia 316A for each series of indicia of measurement, there may be a plurality of solid fill indicia 316A stacked similarly to the liquid fill indicia 312A described below.

The one or more liquid fill indicia 312A can indicate a volume of a series of liquids (e.g., water, soda, tea, coffee, juice, milk, lemonade, simple syrup, syrups, fruit puree, oil, vinegar, honey, agave, liquor, yogurt, or milk alternatives) which can be added to the shaker cup 10 in series. The one or more liquid fill indicia 312A may be indicative of different volumes of liquid depending on the one or more ingredients. The one or more liquid fill indicia 312 may be in a stacked configuration in the vertical direction to indicate the order in which the liquid ingredients should be added. The stacked liquid fill indicia 312A includes a first liquid fill level indicator 320A, a second liquid fill level indicator 322A which is located above the first liquid fill level indicator 320A, and a third liquid fill level indicator 324A which is located above the second liquid fill level indicator 322A. An upper end of each of the liquid fill indicia 312A may include a horizontal fill line to facilitate ease of measurement. Each liquid fill indicia 312A may provide a colored region that extends from the base 25 or the or upper end of the adjacent liquid fill indicia to the horizontal fill line. In some examples, the one or more liquid fill indicators can be spaced apart vertically or in a stacked configuration. In some examples, the height or spacing between each of the plurality of level indicators can vary such that the plurality of level indicators are indicative of different volumes of liquid for the various ingredients. In some examples, the height or spacing between each of the plurality of level indicators can be constant or even such that the plurality of level indicators are indicative of a constant volume of liquids for the various ingredients.

The solid fill indicia 316A and the stacked liquid fill indicia 312A can be positioned separate from (e.g., next to, lateral to) each other so that a granular solid can first be filled up to the solid fill indicia 316A and then one or more liquids can be filled up into the granular solid up the stacked liquid fill indicia 312A. The solid fill indicia 316A can overlap with the stacked liquid fill indicia 312A. In this manner, the one or more solid ingredients can be placed in the cup first.

Advantageously, the stacked liquid fill indicia 312A and solid fill indicia 316A are scaled so that solid ingredients may be placed in the shaker cup 10 before liquid ingredients, thereby allowing a recipe to be easily formed in one container with the proper ratios of solid and liquid ingredients.

The indicia of volume size 314A can indicate the total volume of liquid and solid ingredients to be added to the shaker cup 10. The indicia of volume size 314A may extend laterally from one of the solid fill indicia 316A or liquid fill indicia 312A.

To create a beverage recipe, a granular solid is placed in the shaker cup 10 up to the level of the solid fill indicia 316A, then a first liquid is placed in the shaker cup 10 up to the level of the first liquid fill level indicator 320A. Next, a second liquid is place in the shaker cup 10 so that the total liquid volume in the cup 10 reaches to the level of the second liquid fill level indicator 322A. Next, a third liquid is place in the shaker cup 10 so that the total liquid volume in the cup 10 reaches the level of the third liquid fill level indicator 324A.

The shaker cup 10 can also include a second series of indicia of measurement 310B, a third series of indicia 310C, and a fourth series of indicia 310D. Each series of indicia can indicate measurements for a different sized beverage (e.g., different volumes of each ingredient to form a beverage with a different total volume). Each series of indicia can be spaced around the perimeter of the cup 10 and can include marking indicators visible both from the exterior of the cup 10 and through the clear or transparent cup 10.

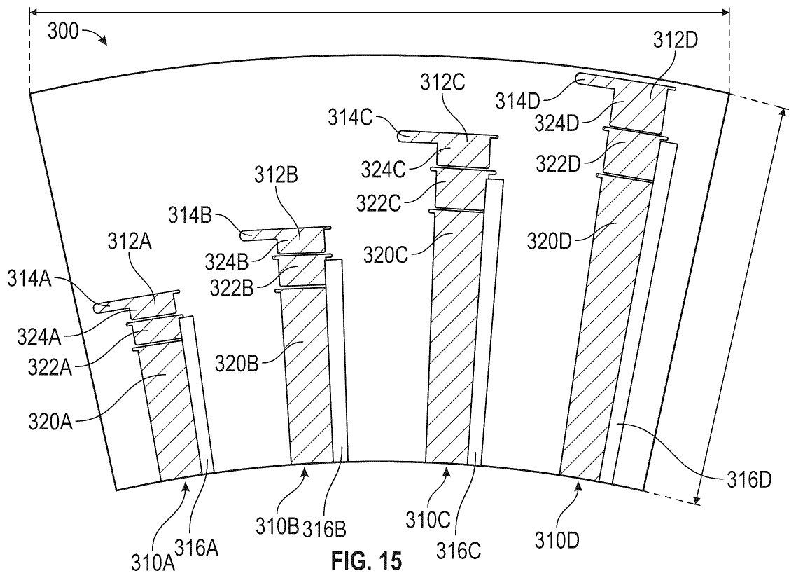

FIG. 15 illustrates a decal 300 which can be shaped and sized to wrap around the perimeter of a shaker cup 10. The decal 300 can include the series of indicia of measurement 310A-310D described above with regard to FIG. 14. The first series of indicia 310A can indicate the volumes of ingredients for a small beverage. The second series of indicia 310B can indicate the volumes of ingredients for a larger beverage than 310A. The third series of indicia 310C can indicate the volumes of ingredients for a larger beverage than 310B. The fourth series of indicia of 310D can indicate the volumes of ingredients for a larger beverage than 310C.

The indicia of measurement 310A can include a solid fill indicia 316A which can indicate a volume of a granular solid which can be added to the shaker cup 10, a stacked liquid fill indicia 312A which can indicate a volume of a series of liquids which can be added to the shaker cup 10, and an indicia of volume size 314A which can indicate the total volume of liquid and solid ingredients to be added to the shaker cup 10. The stacked liquid fill indicia 312A includes a first liquid fill level indicator 320A, a second liquid fill level indicator 322A which is located above the first liquid fill level indicator 320A, and a third liquid fill level indicator 324A which is located above the second liquid fill level indicator 322A.

The indicia of measurement 310B can include a solid fill indicia 316B which can indicate a volume of a granular solid which can be added to the shaker cup 10, a stacked liquid fill indicia 312B which can indicate a volume of a series of liquids which can be added to the shaker cup 10, and an indicia of volume size 314B which can indicate the total volume of liquid and solid ingredients to be added to the shaker cup 10. Each of the stacked liquid fill indicia 312B and the solid fill indicia 316B can be proportionally taller than the stacked liquid fill indicia 312A and the solid fill indicia 316A. The stacked liquid fill indicia 312B includes a first liquid fill level indicator 320B, a second liquid fill level indicator 322B which is located above the first liquid fill level indicator 320B, and a third liquid fill level indicator 324B which is located above the second liquid fill level indicator 322B. Each of the first liquid fill level indicator 320B, second liquid fill level indicator 322B, and third liquid fill level indicator 324B can be proportionally larger than the first liquid fill level indicator 320A, second liquid fill level indicator 322A, and third liquid fill level indicator 324A so that the indicia of measurement 310B forms the same recipe as the indicia of measurement 310A but a larger volume.

The indicia of measurement 310C can include a solid fill indicia 316C which can indicate a volume of a granular solid which can be added to the shaker cup 10, a stacked liquid fill indicia 312C which can indicate a volume of a series of liquids which can be added to the shaker cup 10, and an indicia of volume size 314C which can indicate the total volume of liquid and solid ingredients to be added to the shaker cup 10. Each of the stacked liquid fill indicia 312C and the solid fill indicia 316C can be proportionally taller than the stacked liquid fill indicia 312B and the solid fill indicia 316B. The stacked liquid fill indicia 312C includes a first liquid fill level indicator 320C, a second liquid fill level indicator 322C which is located above the first liquid fill level indicator 320C, and a third liquid fill level indicator 324C which is located above the second liquid fill level indicator 322C. Each of the first liquid fill level indicator 320C, second liquid fill level indicator 322C, and third liquid fill level indicator 324C can be proportionally larger than the first liquid fill level indicator 320B, second liquid fill level indicator 322B, and third liquid fill level indicator 324B so that the indicia of measurement 310C forms the same recipe as the indicia of measurement 310B but a larger volume.

The indicia of measurement 310D can include a solid fill indicia 316D which can indicate a volume of a granular solid which can be added to the shaker cup 10, a stacked liquid fill indicia 312D which can indicate a volume of a series of liquids which can be added to the shaker cup 10, and an indicia of volume size 314D which can indicate the total volume of liquid and solid ingredients to be added to the shaker cup 10. Each of the stacked liquid fill indicia 312D and the solid fill indicia 316D can be proportionally taller than the stacked liquid fill indicia 312C and the solid fill indicia 316C. The stacked liquid fill indicia 312D includes a first liquid fill level indicator 320D, a second liquid fill level indicator 322D which is located above the first liquid fill level indicator 320D, and a third liquid fill level indicator 324D which is located above the second liquid fill level indicator 322D. Each of the first liquid fill level indicator 320D, second liquid fill level indicator 322D, and third liquid fill level indicator 324D can be proportionally larger than the first liquid fill level indicator 320C, second liquid fill level indicator 322C, and third liquid fill level indicator 324C so that the indicia of measurement 310D forms the same recipe as the indicia of measurement 310C but a larger volume.

In some examples, one or more of the indicia of measurements can include solid fill indicia and stacked liquid fill indicia which relate to a different recipe. In some examples, the decal 300 can include 1, 2, 3, 4, 5, 6, 7, 8 or more separate indicia of measurement. In some examples, the stacked liquid fill indicia can include 1, 2, 3, 4, 5, or more liquid fill level indicators. In some examples, there can be more than one solid fill indicia. For example, 1, 2, 3, 4, 5, or 6 solid fill indicia.

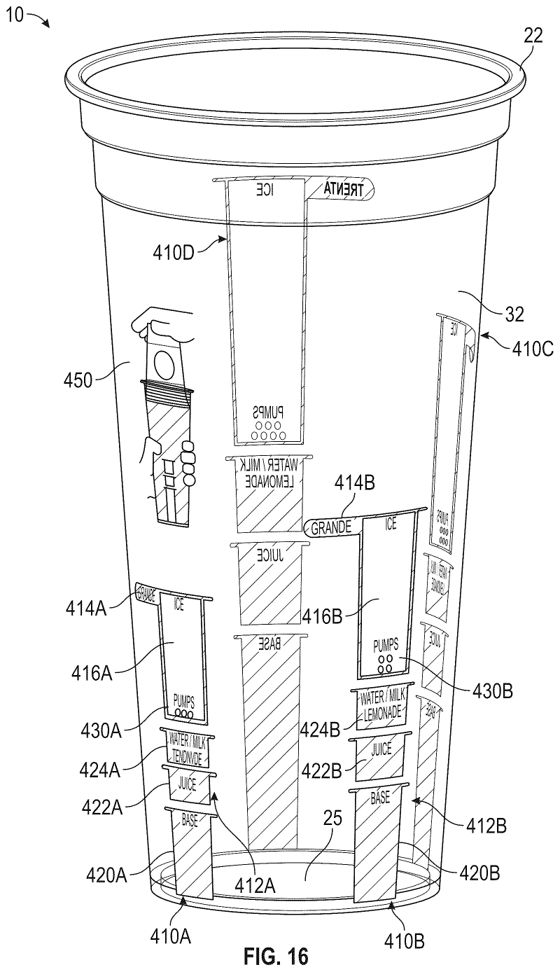

FIG. 16 illustrates a shaker cup 10 including a body 32. The shaker cup 10 can include any of the features of the shaker cups 10, 10A described above. A rim 22 can define the opening of the cup 10 and a base 25 can be positioned opposite from the rim 22. As illustrated, the shaker cup 10 can be clear or translucent.

The shaker cup 10 can include one or more series of indicia of measurement 410A, 410B, 410C, 410D. Similar to the series of indicia measurement 310A, 310B, 310C, 310D, the one or more series of indicia of measurement 410A, 410B, 410C, 410D can indicate a volume or amount of various ingredients of a beverage within the shaker cup 10. For example, the shaker cup 10 can include a plurality of series of indicial of measurement, e.g., two series, three series, four series, five series, or more, or ranges therebetween any of the afore-mentioned values.

The shaker cup 10 can a first series of indicia of measurement 410A. The indicia of measurement 410A can begin at the base 25 and extend toward the rim 22 so that liquid ingredients (e.g., water, soda, tea, coffee, oil, juice, milk, lemonade, simple syrup, fruit puree, vinegar, honey, agave, yogurt, liquor, or milk alternatives) and solid ingredients (e.g., ice, chocolate, fruit, boba, nuts, syrup, oats, or protein powder) can be placed in the shaker cup 10 and can be measured by looking through the clear or translucent shaker cup 10 and identifying that the ingredient has reached the appropriate indicia of measurement 410A. The indicia of measurement 410A can include one or more solid fill indicia 416A, one or more liquid fill indicia 412A, an indicia of volume size 414A, and/or one or more dispenser indicia 430A.

The one or more solid fill indicia 416A can indicate a volume of a granular solid (e.g., ice, chocolate, fruit, nuts, oats, or protein powder) which can be added to the shaker cup 10.

The one or more liquid fill indicia 412A can indicate a volume of a series of liquids (e.g., water, soda, tea, coffee, juice, milk, lemonade, simple syrup, syrups, fruit puree, oil, vinegar, honey, agave, liquor, yogurt, or milk alternatives) which can be added to the shaker cup 10 in series. The one or more liquid fill indicia 412A may be indicative of different volumes of liquid depending on the one or more ingredients. The one or more liquid fill indicia 412 may be in a stacked configuration in the vertical direction to indicate the order in which the liquid ingredients should be added. The stacked liquid fill indicia 412A includes a first liquid fill level indicator 420A, a second liquid fill level indicator 422A which is located above the first liquid fill level indicator 420A, and a third liquid fill level indicator 424A which is located above the second liquid fill level indicator 422A. An upper end of each of the liquid fill indicia 412A may include a horizontal fill line to facilitate ease of measurement. Each liquid fill indicia 412A may provide a colored region that extends from the base 25 or the or upper end of the adjacent liquid fill indicia to the horizontal fill line.

The solid fill indicia 416A can be positioned above the stacked liquid fill indicia 312A. One or more liquids can be filled up to the stacked liquid fill indicia 412A. The granular solid can be poured into the one or more liquids in the cup 10 such that the granular solid can fill up to the stacked liquid fill indicia 412A and above the liquid to the solid fill indicia 416A.

Advantageously, the stacked liquid fill indicia 412A and solid fill indicia 416A are scaled so that liquid ingredients may be placed in the shaker cup 10 before the solid ingredients, thereby allowing a recipe to be easily formed in one cup with the proper ratios or proportions of solid and liquid ingredients. In this manner, the solid ingredient can be placed in the cup last. This can advantageously avoid the solid ingredients from interfering with the measurements of the liquid ingredients to the liquid fill indicia 412A.

The indicia of volume size 414A can indicate the total volume of liquid and solid ingredients to be added to the shaker cup 10. The indicia of volume size 414A may extend laterally from one of the solid fill indicia 416A or liquid fill indicia 412A.

The one or more dispenser indicia 430A can indicate the total number of pumps of an ingredient, which can be a flavoring liquid a syrup or other ingredient. The one or more dispenser indicia 430A can indicate an ingredient that is added to the beverage with a pump. The one or more dispenser indicia 430A can indicate an ingredient that is added to the beverage by other dispensers, such as scoops from a container or shakes from shaker dispenser. The one or more dispenser indicia 430A can be positioned within the solid fill indicia 416A. The one or more dispenser indicia 430A can be positioned on a lower portion of the solid fill indicia 416A. The position within the solid fill indicia 416A can indicate additional ingredients, such as flavorings or toppings, can be added before the solids are added. In other words, a user would follow the order of steps indicated by the indicia of measurement 410A in a direction from the base 25 towards the rim 22 of the cup 10. The one or more dispenser indicia 430A can include one or more icons, such as dots, squares, triangles, rings, lines, stars, or other symbols. The number of icons of the dispenser indicia 430A can indicate the number of portions or servings of an ingredient to be dispensed for the beverage.

To create or execute a beverage from a beverage recipe, a first liquid is placed in the shaker cup 10 up to the level of the first liquid fill level indicator 420A. Next, a second liquid is placed in the shaker cup 10 so that the total liquid volume in the cup 10 reaches to the level of the second liquid fill level indicator 422A. Next, a third liquid is placed in the shaker cup 10 so that the total liquid volume in the cup 10 reaches the level of the third liquid fill level indicator 424A. Then, an additional ingredient, such as a flavoring or topping, can be dispensed into the beverage based on the number of icons of the one or more dispenser indicia 430A. Then, a granular solid is placed in the shaker cup 10 up to the level of the solid fill indicia 416A.

The shaker cup 10 can also include a second series of indicia of measurement 410B, a third series of indicia 410C, and a fourth series of indicia 410D. Each series of indicia can indicate measurements for a different sized beverage (e.g., different volumes of each ingredient to form a beverage with a different total volume). Each series of indicia can be spaced around the perimeter of the cup 10 and can include marking indicators visible both from the exterior of the cup 10 and through the clear or transparent cup 10.

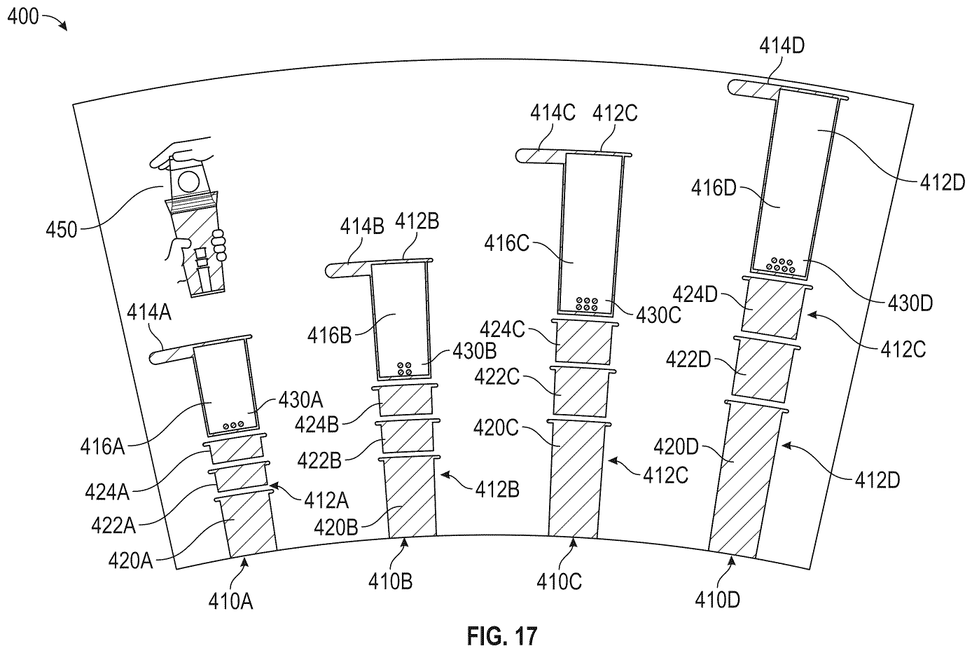

As shown in FIGS. 16-17, each of the series of indicia of measurements 410A-410D can include a solid fill indicia 416A-D that is positioned above the liquid fill indicia 412A-D. In this manner, each indicia of measurement 410A-410D can facilitate a recipe where a solid, such as ice, can be filled as the last step. In contrast, the series of indicia 410A-410D of measurements 310A-310D in FIGS. 14-15 can include solid fill indicia 316A-316D that is positioned adjacent to the liquid fill indicia 312A-D. In this manner, each indicia of measurement 310A-310D can facilitate a recipe where a solid, such as ice, can be filled as the first step.

FIG. 17 illustrates a decal 400 which can be shaped and sized to wrap around the perimeter of a shaker cup 10. The decal 400 can include the series of indicia of measurement 410A-410D described above with regard to FIG. 15. The first series of indicia 410A can indicate the volumes of ingredients for a small beverage. The second series of indicia 410B can indicate the volumes of ingredients for a larger beverage than 410A. The third series of indicia 410C can indicate the volumes of ingredients for a larger beverage than 410B. The fourth series of indicia of 410D can indicate the volumes of ingredients for a larger beverage than 410C.

The indicia of measurement 410A can include a stacked liquid fill indicia 412A which can indicate a volume of a series of liquids which can be added to the shaker cup 10. The indicia of measurement 410A can include an indicia of volume size 414A which can indicate the total volume of liquid and solid ingredients to be added to the shaker cup 10. The stacked liquid fill indicia 412A includes a first liquid fill level indicator 420A, a second liquid fill level indicator 422A which is located above the first liquid fill level indicator 420A, and a third liquid fill level indicator 424A which is located above the second liquid fill level indicator 422A. The indicia of measurement 410A can include a solid fill indicia 416A which can indicate a volume of a granular solid which can be added to the shaker cup 10. The solid fill indicia 416A can be stacked above or positioned on top of a stacked liquid fill indicia 412A. The solid fill indicia 416A can be located above the third liquid fill indicator 424A. The indicia of measurement 410A can include a dispenser indicia 430A, which can indicate a number of portions of an additional ingredient, such as a number of pumps of syrup, which can be added to the shaker cup.

The indicia of measurement 410B can include a stacked liquid fill indicia 412B which can indicate a volume of a series of liquids which can be added to the shaker cup 10. The indicia of measurement 410B can include a solid fill indicia 416B which can indicate a volume of a granular solid which can be added to the shaker cup 10. The indicia of measurement 410B can include a dispenser indicia 430B, which can indicate a number of portions of an additional ingredient, such as a number of pumps of syrup, which can be added to the shaker cup. The indicia of measurement 410B can include an indicia of volume size 414B which can indicate the total volume of liquid and solid ingredients to be added to the shaker cup 10. Each of the stacked liquid fill indicia 412B and the solid fill indicia 416B can be proportionally taller than the stacked liquid fill indicia 412A and the solid fill indicia 416A. The stacked liquid fill indicia 412B includes a first liquid fill level indicator 420B, a second liquid fill level indicator 422B which is located above the first liquid fill level indicator 420B, and a third liquid fill level indicator 424B which is located above the second liquid fill level indicator 422B. Each of the first liquid fill level indicator 420B, second liquid fill level indicator 422B, and third liquid fill level indicator 424B can be proportionally larger than the first liquid fill level indicator 420A, second liquid fill level indicator 422A, and third liquid fill level indicator 424A so that the indicia of measurement 410B forms the same recipe as the indicia of measurement 410A but a larger volume. Similarly, the solid fill indicia 416B, which can be positioned above the liquid fill indicia 412A, can be proportionally larger than the liquid fill indicia 412B such that the indicia of measurement 410B forms the same recipe as the indicia of measurement 410A but a larger volume. Similarly, the number of icons of the dispenser indicia 410B can be proportionally larger than the number of icons of the dispenser indicia 410A.

The indicia of measurement 410C can include a stacked liquid fill indicia 412C which can indicate a volume of a series of liquids which can be added to the shaker cup 10. The indicia of measurement 410C can include a solid fill indicia 416C which can indicate a volume of a granular solid which can be added to the shaker cup 10. The indicia of measurement 410C can include a dispenser indicia 430C, which can indicate a number of portions of an additional ingredient, such as a number of pumps of syrup, which can be added to the shaker cup. The indicia of measurement 410C can include an indicia of volume size 414C which can indicate the total volume of liquid and solid ingredients to be added to the shaker cup 10. Each of the stacked liquid fill indicia 412C and the solid fill indicia 416C can be proportionally taller than the stacked liquid fill indicia 412B and the solid fill indicia 416B. The stacked liquid fill indicia 412C includes a first liquid fill level indicator 420C, a second liquid fill level indicator 422C which is located above the first liquid fill level indicator 420C, and a third liquid fill level indicator 424C which is located above the second liquid fill level indicator 422C. Each of the first liquid fill level indicator 420C, second liquid fill level indicator 422C, and third liquid fill level indicator 424C can be proportionally larger than the first liquid fill level indicator 420B, second liquid fill level indicator 422B, and third liquid fill level indicator 424B so that the indicia of measurement 410C forms the same recipe as the indicia of measurement 410B but a larger volume. Similarly, the solid fill indicia 416C, which can be positioned above the liquid fill indicia 412C, can be proportionally larger than the liquid fill indicia 412C such that the indicia of measurement 410C forms the same recipe as the indicia of measurement 410B but a larger volume. Similarly, the number of icons of the dispenser indicia 410C can be proportionally larger than the number of icons of the dispenser indicia 410B.

The indicia of measurement 410D can include a solid fill indicia 416D which can indicate a volume of a granular solid which can be added to the shaker cup 10, a stacked liquid fill indicia 412D which can indicate a volume of a series of liquids which can be added to the shaker cup 10, and an indicia of volume size 414D which can indicate the total volume of liquid and solid ingredients to be added to the shaker cup 10. The indicia of measurement 410C can include a dispenser indicia 430C, which can indicate a number of portions of an additional ingredient, such as a number of pumps of syrup, which can be added to the shaker cup. Each of the stacked liquid fill indicia 412D and the solid fill indicia 416D can be proportionally taller than the stacked liquid fill indicia 412C and the solid fill indicia 416C. The stacked liquid fill indicia 412D includes a first liquid fill level indicator 420D, a second liquid fill level indicator 422D which is located above the first liquid fill level indicator 420D, and a third liquid fill level indicator 424D which is located above the second liquid fill level indicator 422D. Each of the first liquid fill level indicator 420D, second liquid fill level indicator 422D, and third liquid fill level indicator 424D can be proportionally larger than the first liquid fill level indicator 420C, second liquid fill level indicator 422C, and third liquid fill level indicator 424C so that the indicia of measurement 410D forms the same recipe as the indicia of measurement 410C but a larger volume. Similarly, the solid fill indicia 416D, which can be positioned above the liquid fill indicia 412D, can be proportionally larger than the liquid fill indicia 412D such that the indicia of measurement 410D forms the same recipe as the indicia of measurement 410C but a larger volume. Similarly, the number of icons of the dispenser indicia 410D can be proportionally larger than the number of icons of the dispenser indicia 410C.

In some examples, one or more of the indicia of measurements can include solid fill indicia and stacked liquid fill indicia which relate to a different recipe. In some examples, the decal 400 can include 1, 2, 3, 4, 5, 6, 7, 8 or more separate indicia of measurement. In some examples, the stacked liquid fill indicia can include 1, 2, 3, 4, 5, or more liquid fill level indicators. In some examples, there can be more than one solid fill indicia. For example, 1, 2, 3, 4, 5, or 6 solid fill indicia.

The shaker cup 10 can include a graphic 450 that can illustrate a method of using the shaker cup 10. As shown in FIGS. 16-17, the graphic 450 can illustrate a shaker cup 10, an inverted drink cup positioned on top of the shaker cup 10. The shaker cup 10 and inverted drink cup can form an assembly that allows a user to shake the ingredients of the beverage within the volume of the shaker cup 10 and the drinking cup. The graphic 450 can also illustrate the suggested placement of a user's hand or hands. The graphic 450 can illustrate one hand positioned around the middle of the shaker cup 10 and another hand positioned on the bottom surface of the drinking cup (which is positioned at the top of the assembly as the drinking cup is inverted and positioned on top of the shaker cup 10). This hand placement advantageously allows the user to shake the assembly in a stable manner while maintaining the seal between the shaker cup 10 and the drink cup.

### Certain Terminology

As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like).

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or”means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

### Summary

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. The figures are drawn to scale, but such scale should not be interpreted to be limiting. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A shaker cup, comprising:
a body defining a first interior;
a rim defining an opening;
a first ridge of a first ridge diameter positioned below the rim, the first ridge configured to receive a first serving cup of a first size;
a second ridge of a second ridge diameter positioned below the first ridge, the second ridge configured to receive a second serving cup of a second size, the first ridge diameter being larger than the second ridge diameter;
a solid fill indicia, indicating a volume of granular solid for a beverage recipe,
a liquid fill indicia, indicating a volume of liquid for the beverage recipe.

2. The shaker cup of claim 1, wherein the first ridge comprises a first planar surface that is concentric to the rim, wherein the second ridge comprises a second planar surface that is concentric to the first ridge.

3. The shaker cup of claim 1, further comprising an indicia of volume size for the beverage recipe, wherein the indicia of volume size is part of or connected to a horizontal line of the solid fill indicia or the liquid fill indicia.

4. The shaker cup of claim 1, wherein the solid fill indicia comprises an opaque portion and the liquid fill indicia comprises a clear portion.

5. The shaker cup of claim 1, wherein the liquid fill indicia overlaps with the solid fill indicia.

6. The shaker cup of claim 1, wherein the solid fill indicia is positioned above the liquid fill indicia.

7. The shaker cup of claim 1, wherein the liquid fill indicia comprises a plurality of level indicators.

8. The shaker cup of claim 7, wherein a height or a length of each of the plurality of level indicators varies based on proportions of ingredients of at least one beverage recipe.

9. The shaker cup of claim 7, wherein the plurality of level indicators in a stacked configuration.

10. The shaker cup of claim 1, further comprising an indicia of volume size of a beverage recipe.

11. The shaker cup of claim 10, wherein the indicia of volume size indicates a total volume of liquid and solid ingredients for a beverage recipe.

12. The shaker cup of claim 1, wherein the solid fill indicia is a first solid fill indicia of a first series of indicia and the liquid fill indicia is a first liquid fill indicia of the first series of indicia, wherein the first series of indicia indicates volumes of ingredients for a first size of beverage.

13. The shaker cup of claim 12, further comprising a second series of indicia to indicate volumes of ingredients for a second size of beverage, wherein the second series of indicia comprises a second solid fill indicia and a second liquid fill indicia.

14. The shaker cup of claim 13, wherein the second liquid fill indicia is proportionally taller than the first liquid fill indicia, wherein the second solid fill indicia is proportionally taller than the first solid fill indicia.

15. A shaker cup and serving cup assembly, comprising:
a shaker cup comprising:
a body defining a first interior,
a rim defining an opening,
a first ridge of a first ridge diameter positioned below the rim,
a second ridge of a second ridge diameter positioned below the first ridge, the first ridge diameter is larger than the second ridge diameter,
a solid fill indicia, indicating a volume of granular solid for a beverage recipe, and
a liquid fill indicia, indicating a volume of liquid for the beverage recipe;
a first serving cup of a first size; and
a second serving cup of a second size,
wherein the first size and the second size are different,
wherein the first ridge of the shaker cup is configured to receive the first serving cup,
wherein the second ridge of the shaker cup is configured to receive the second serving cup.

16. The shaker cup and serving cup assembly of claim 15, wherein the first serving cup is configured to be inverted such that an open end of the first serving cup is positioned below a closed end of the first serving cup when the first serving cup is received by the shaker cup.

17. The shaker cup and serving cup assembly of claim 15, wherein the shaker cup comprises a first material, wherein the first serving cup and the second serving cup comprises a second material, wherein the first material is more rigid than the second material.

18. A method for preparing a beverage, the method comprising:
placing one or more ingredients in a shaker cup;
positioning a first serving cup of a first size or a second serving cup of a second size on top of the shaker cup to seal the shaker cup, wherein the first size is different from the second size;
placing a granular solid and a liquid in the shaker cup to an indicia;
shaking the shaker cup and the first or second serving cup together;
removing the shaker cup from the first or second serving cup; and
serving the beverage in the first or second serving cup.

19. The method of claim 18, wherein placing the granular solid and the liquid in the shaker cup to the indicia comprises:
placing the granular solid in the shaker cup up to a first indicia; and
placing the liquid in the shaker cup up to a second indicia.

20. The method of claim 18, wherein placing the granular solid and the liquid in the shaker cup to the indicia comprises:
placing the liquid in the shaker cup up to a first indicia; and
placing the granular solid in the shaker cup up to a second indicia.
